(19) United States
(12) Patent Application Publication
(10) Pub. No.: US 2006/0150433 A1
(43) Pub. Date: Jul. 13, 2006

(54) Body blow drying system

(76) Inventor: Jennis Ahillia Verise-Gonzalez, Douglaston, NY (US)

Correspondence Address: Jennis A. Verise-Gonzalez, 245-16 Rushmore Ave, Douglaston, NY, 11362, US

(21) Appl. No.: 10/956,779

(22) Filed: Jan. 12, 2005

(51) Int. Cl. F26B 19/00; F26B 25/06

(52) U.S. Cl. 34/201; 34/229

(57) ABSTRACT

The main materials that will be used to create the Wall Mount Body Blow Drying System is as follows: Stainless Steel Plastic Rubber Metal It features the following: Control Panel with On/Off power switch, Temperature control of Hot/Warm/Cold and a Speed Control switch with options for High/Med/Low 16-3″ inch oscillating adjustable nozzles 12″ inch L-shaped hand held dryer A Cradle to rest the hand piece Rubber tubing that extends 34 feet for flexibility The dimensions are 72″ inches in height by 24″ inches in width by 12″ inches in depth The main materials that will be used to create the Free Standing Body Blow Dryer is as follows: Plastic Rubber Metal It features the following: Control Panel with On/Off power switch, Temperature control of Hot/Warm/Cold and a Speed Control switch with options for High/Med/Low 7-3″ inch adjustable nozzles 9″ inch retractable collar A Weighted Metal Base The dimensions are 58″ inches in height by 12″ inches in width by 12″ inches in depth Both products will be designed according to required electrical coding.

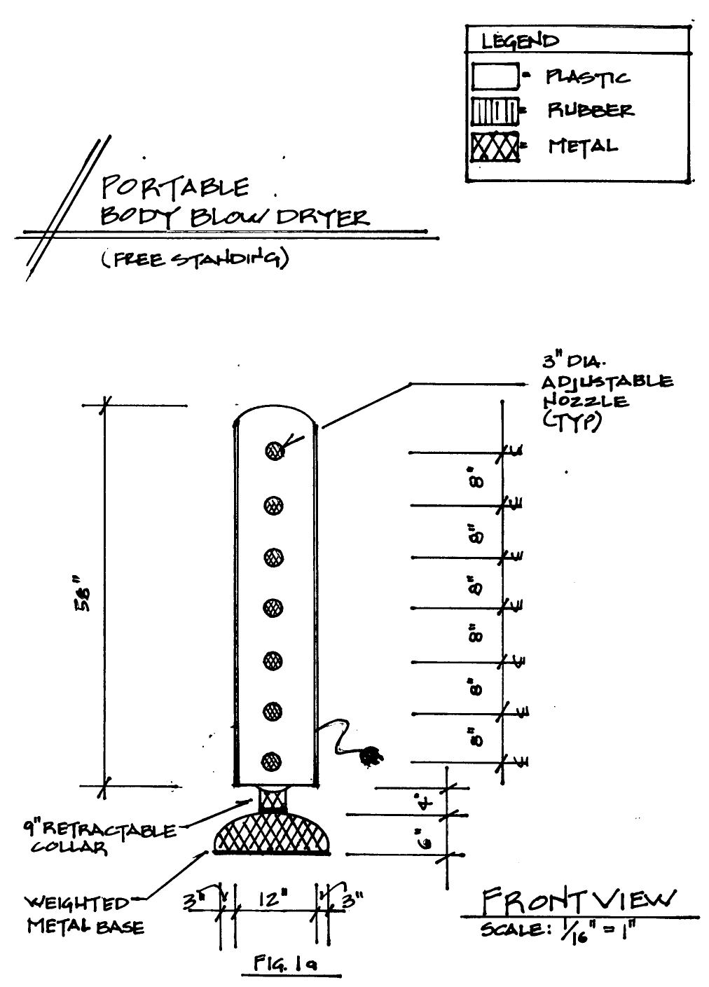

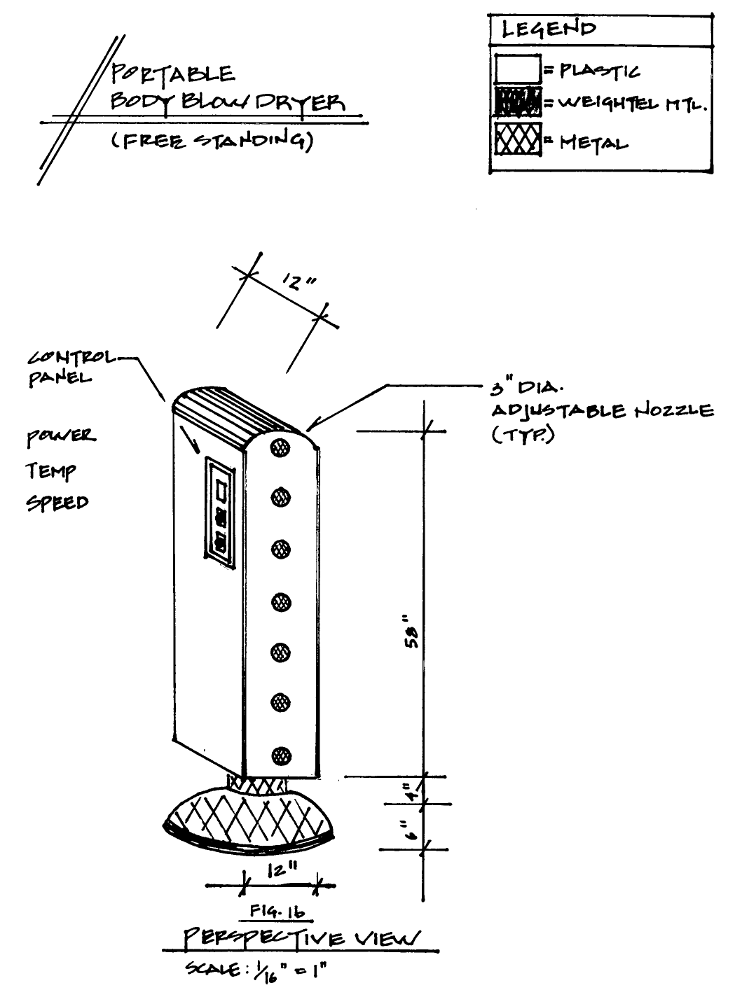

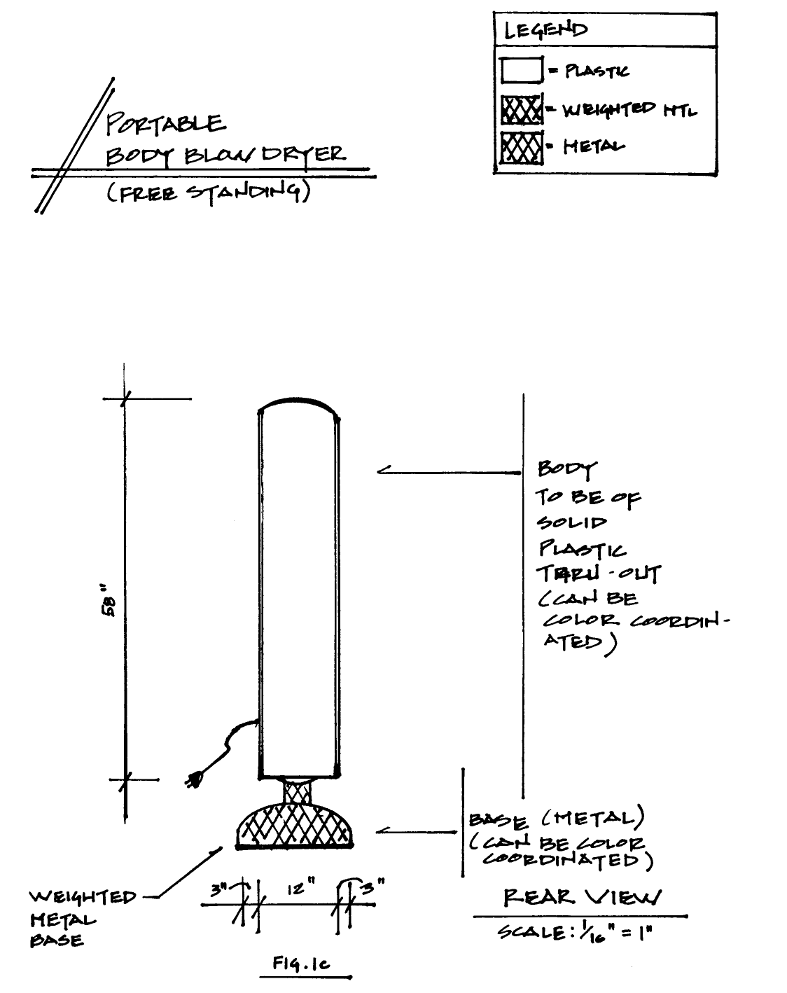

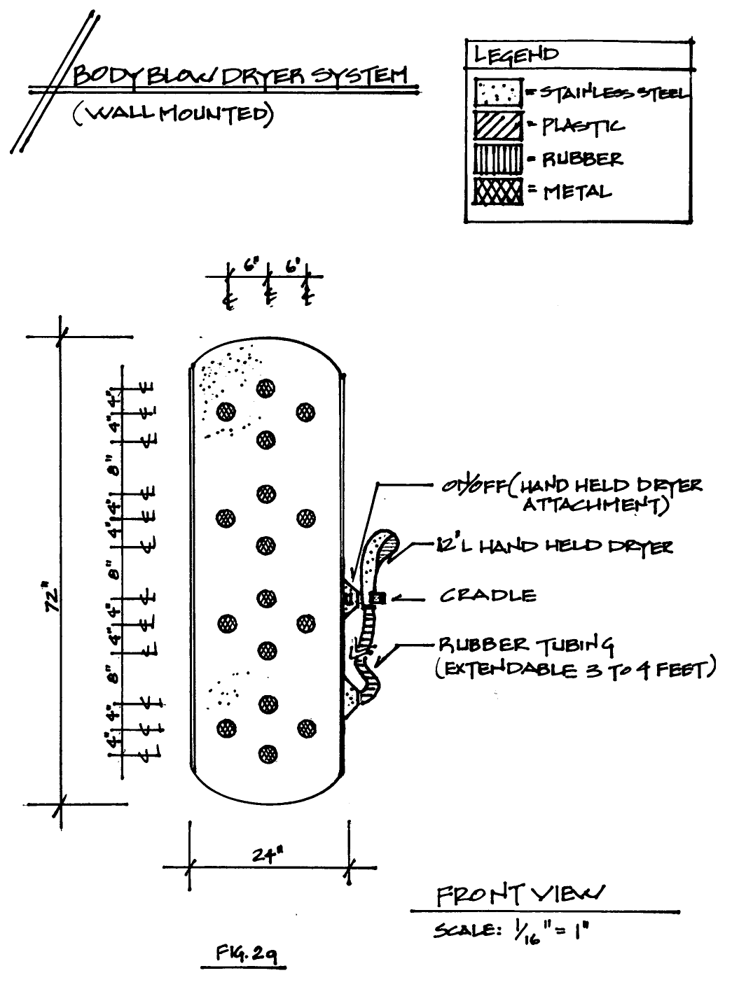

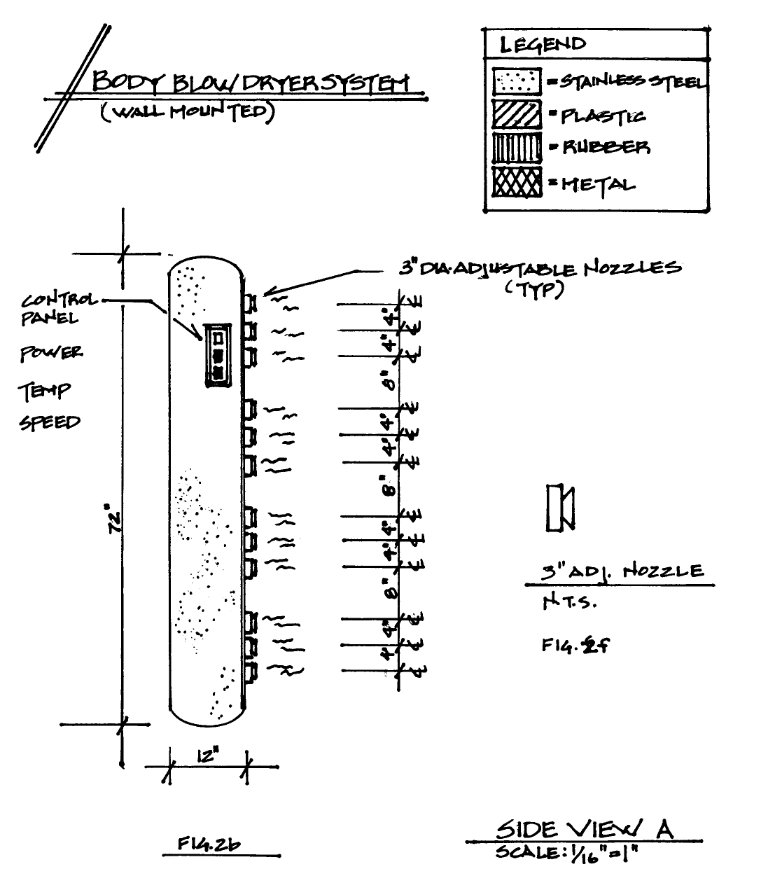

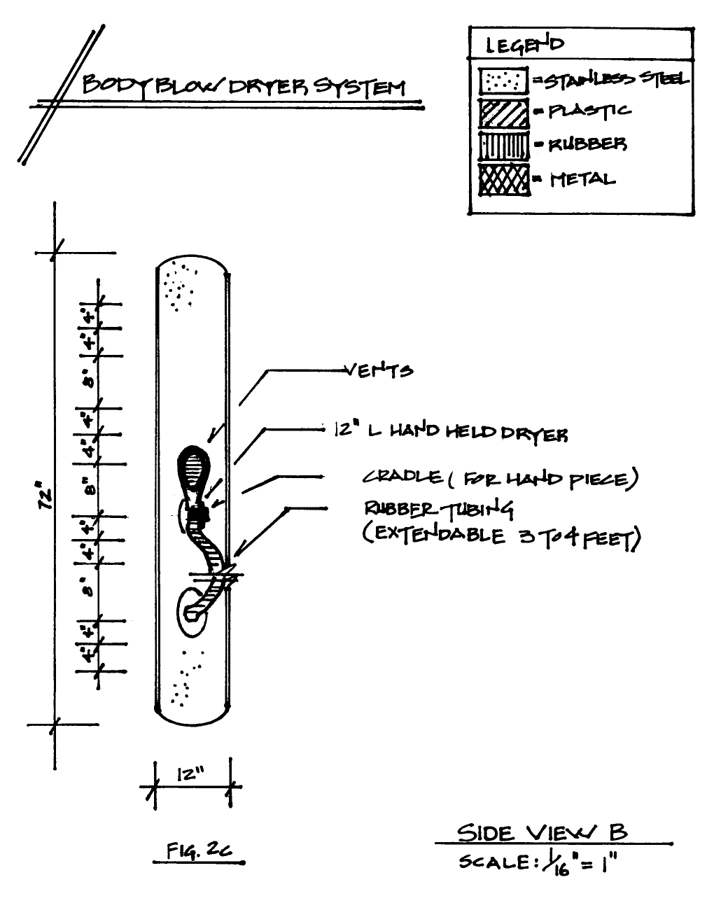

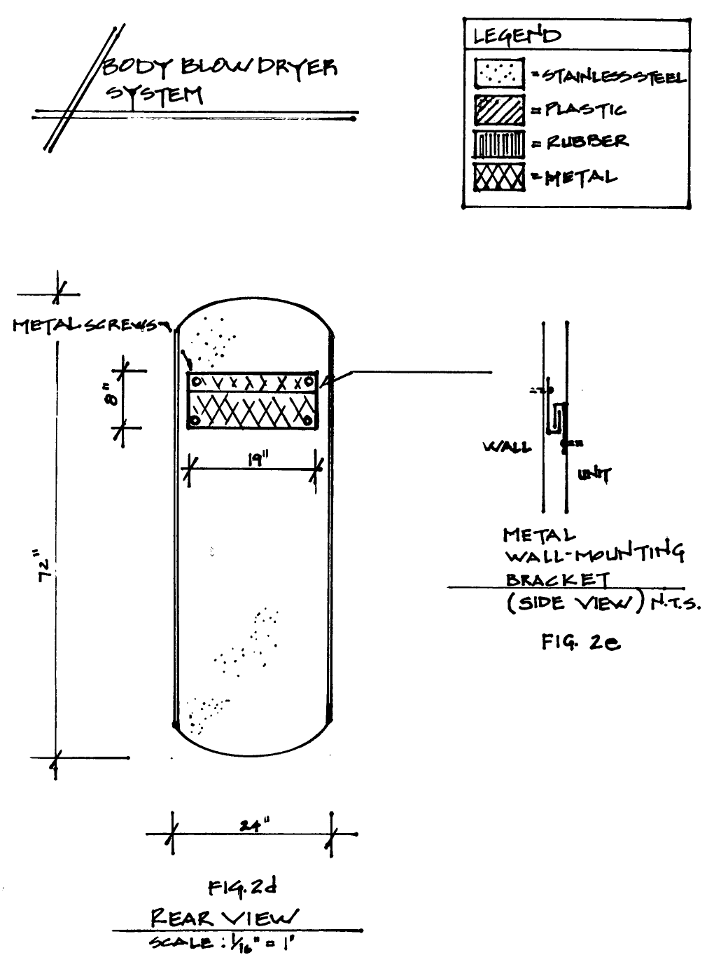

The Body Blow Drying System is a unique, sanitary and towel free product. It was designed with multiple uses in mind. The following are areas were this product would be most beneficial:
People that suffer with various disabilities. (Arthritis, MS, Back, Neck& Body injuries)
Homemakers, such as myself that wash loads of towels weekly.
Nursing Homes
Hospitals
Hotels
Locker Rooms
Etc.

The system was designed to be user friendly. It would be made available in a wall mount, or portable version. Both versions would have the ease of an ON and OFF switch.

Both would have a temperature control and an oscillating feature. The system price will vary from $100-$300 for the portable and $1,500-$3,000 for the wall mount version.

This system was designed to be safe, cost effective and time efficient. I am confident that not only is this product going to prove to be beneficial, but also the areas of possibilities are endless.

1. I claim that this body blow drying system is a unique, sanitary and towel free product.
